(19) United States
(12) Patent Application Publication
(10) Pub. No.: US 2006/0106723 A1
(43) Pub. Date: May 18, 2006

(54) Supporting the use of encrypted media objects

(75) Inventor: Sami Pippuri, Espoo (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/988,198

(22) Filed: Nov. 12, 2004

(51) Int. Cl. H04L 9/00

(52) U.S. Cl. 705/57

(57) ABSTRACT

The invention relates to supporting a flexible use of encrypted media objects at an electronic device 10. The encrypted media objects are received at the device 10 in at least one data package. The data package includes in addition a non-editable playlist, which comprises a respective reference to at least one encrypted media object. Upon receipt of such a data package, a new, editable playlist is created. To this editable playlist, either at least one referenced encrypted media object in the at least one data package or a reference to a storage location of at least one referenced encrypted media object from the at least one data package in the electronic device 10 is added.

### FIELD OF THE INVENTION

The invention relates to supporting a use of encrypted media objects at an electronic device.

### BACKGROUND OF THE INVENTION

To an electronic device, various types of media content can be made available, which is suited for consumption by a user of the device. For example, a content provider can provide music or video files for download via the Internet. An electronic device, which enables a user to consume available content can be, for instance, a mobile terminal or a personal computer (PC), in which a content player, like a music player, is implemented.

Many content providers have an interest in ensuring that distributed content can only be used by authorized users, for example users that have been charged for the content.

The Open Mobile Alliance™ (OMA) specifies a digital rights management (DRM) which allows distributing content that is protected by encryption. The encrypted content can be used by means of an electronic device, which is in addition in possession of a rights object (RO) generated specifically for this device. The rights object contains an encryption key that is required for decryption of the protected content by the device for which it has been generated.

Currently, each DRM protected music track has to be downloaded separately from online stores. That is, even if whole albums may be offered at a reduced rate compared to single music tracks, downloads are still carried out per track. Equally, the storage of the music tracks in an electronic user device is carried out track-by-track.

Obviously, a download of bundled music tracks would be more convenient to a user. For unprotected content, for instance for music tracks in an unprotected MP3 format, it is known to bundle content for download over the Internet.

The OMA™ defines in the document “DRM Content Format Candidate Version 2.0-15 Jul. 2004, Open Mobile Alliance, OMA-DRM-DCF-V2_{—}0-20040715-C” a DRM content format (DCF) for a data file. In addition, it defines multipart OMA™ DRM containers, which provide a basis for bundling content into a single package, namely a multipart DCF package. The use of a multipart DCF package is limited, though, since its entire content is read-only content and can thus not be rearranged by a user for consumption according to user preferences.

### SUMMARY OF THE INVENTION

It is an object of the invention to enable a flexible access to protected media content, which is provided in a read-only data package to an electronic device.

For an electronic device, a method for supporting a use of encrypted media objects is proposed. The method comprises receiving at least one data package, which at least one data package includes at least one encrypted media object and a non-editable playlist, wherein the non-editable playlist includes a respective reference to at least one encrypted media object in the at least one data package. The method further comprises creating a new, editable playlist. The method further comprises adding to the editable playlist either at least one referenced encrypted media object in the at least one data package or a reference to a storage location of at least one referenced encrypted media object from the at least one data package in the electronic device.

Moreover, an electronic device is proposed, which comprises a processing module. The processing module is adapted to receive at least one data package, which at least one data package includes at least one encrypted media object and a non-editable playlist, wherein the non-editable playlist includes a respective reference to at least one encrypted media object in the at least one data package. The processing module is further adapted to create a new, editable playlist. The processing module is further adapted to add to the editable playlist either at least one referenced encrypted media object in the at least one data package or a reference to a storage location of at least one referenced encrypted media object from the at least one data package in the electronic device. The electronic device can be any device which enables a user to consume encrypted media objects, for example a music player, a video player, or a device comprising such a media player, like a mobile terminal or a PC.

Moreover, a data communication system is proposed, which comprises such an electronic device. In addition, the system may comprise a content server and/or a data communication network enabling a data exchange between the electronic device and the content server.

For an electronic device, moreover a software program product is proposed, in which a software code for supporting a use of encrypted media objects is stored. When running in an electronic device, the software code realizing the method proposed for an electronic device.

For a content server providing a data package including at least one encrypted media object to an electronic device, a method for supporting a use of encrypted media objects at an electronic device is proposed. The method comprises generating a non-editable playlist, wherein the non-editable playlist includes a respective reference to at least one encrypted media object which is to be included in the data package. The method further comprises assembling the non-editable playlist and at least one encrypted media object in the data package. The method further comprises providing the data package for transmission to the electronic device.

Moreover, a content server providing encrypted media objects to electronic devices is proposed. The content server comprises an assembling module. This assembling module is adapted to generate a non-editable playlist, wherein the non-editable playlist includes a respective reference to at least one encrypted media object which is to be provided by the content server to an electronic device. The assembling module is further adapted to assemble the non-editable playlist and the at least one encrypted media object in a data package. The assembling module is further adapted to provide the data package for transmission to an electronic device.

Moreover, a data communication system is proposed, which comprises the proposed content server. The data communication system may comprise in addition a data communication network enabling a data exchange between the content server and an electronic device. The content server may be part of such a network or be attached to such a network.

For a content server providing a data package including at least one encrypted media object to an electronic device, moreover a software program product is proposed, in which a software code for supporting a use of encrypted media objects at an electronic device is stored. When running in a content server, the software code realizing the method proposed for a content server.

Finally, a playlist format for a non-editable playlist, which is to be assembled together with at least one encrypted media object in a data package, is proposed. The playlist format defines a respective field for a reference to at least one encrypted media object which is to be included in the data package.

The invention proceeds from the consideration that a data package with bundled encrypted media objects could include a playlist file as an additional content object. This playlist could then include references to the encrypted media objects. When used for example in the context of the OMA™ DRM specification, however, it is a drawback of such a playlist that it is not editable. Thus, the user cannot rearrange the playlist, and the user is always forced to accept all media objects in the package in the given order for a playback. It is therefore proposed in addition that the non-editable playlist in a data package received at an electronic device is detected and that the associated encrypted media objects are added to a newly created editable playlist. Alternatively, not the encrypted media objects as such, but only references to their storage locations are added.

It is to be understood that the non-editable playlist may comprise a reference to all media objects included in the data package or only to selected media objects included in the data package. That is, the data package may comprise media objects which are not considered in the non-editable playlist.

It is further to be understood that the editable playlist may be generated automatically from all referenced media objects in the non-editable playlist. Alternatively, however, the editable playlist may be generated from selected referenced media objects in the non-editable playlist, for instance based on a user input indicating which referenced media objects are to be considered for the editable playlist and/or which referenced media objects are not to be considered in the editable playlist. Also the generation of the editable playlist as such may be started automatically upon reception of the data package or be initiated by a user request.

It is an advantage of the invention that it supports a bundling of content objects at a content provider end. It is further an advantage of the invention that it enables a user to generate his/her own playlists and to modify them freely. For example, the editable playlist can be rearranged, and media objects can be added or deleted without restrictions.

It is further an advantage of the invention that the implementation is quite simple. At the same time, it is ensured that the protection of the media objects is not affected.

Advantageously, the presence of a non-editable playlist is indicated in the data package, for example in a header portion of the data package or in a header portion of a container containing the playlist. This indication enables the electronic device to recognize immediately that the data package includes a non-editable playlist when receiving the data package and to take care of the data package using an application, which is adapted to handle the non-editable playlist format, for instance a suitable media player.

The reference to a respective media object, which is included in the non-editable playlist, may be for example a media object identifier.

In addition to the references to media objects, the non-editable playlist may include various other information items.

In a further embodiment of the invention, the non-editable playlist includes at least one additional attribute, which is taken into account by the electronic device for handling the encrypted media objects.

Such an additional attribute can be, for example, a burn count.

It is a drawback of a non-editable playlist that a ‘burn to CD’ functionality of the playlist cannot be controlled by a digital rights management, like the OMA™ DRM. Such a feature is desirable from a content provider's point of view, though. Usually, it is not required, though, that such a feature provides the same grade of security as the encryption of the media objects. With the new editable playlist, it is possible to express playlist CD burning controls outside of the DRM constraints, for example on an application level.

The burn count attribute in the non-editable playlist may indicate to this end a number of copies which are allowed to be produced from the encrypted media objects in the data playlist. When producing the editable playlist, the burn count may then be associated in the electronic device to the new editable playlist. The burn count may further be updated whenever the playlist is burned onto a CD or copied to another medium.

Another additional attribute can be, for example, a creation date, which enables the electronic device to monitor a period of time during which the user is able to use the playlist burn count specified in the non-editable playlist.

Other additional information items, which may be included in a non-editable playlist for use by the electronic device are, for example, an indication of a title of the playlist, an indication of the length of a respective media object and/or an indication of a title of a respective media object.

The proposed playlist format defines a respective field for each additional information item, which might have to be included in a non-editable playlist.

In another embodiment of the invention, the electronic device may receive at least one further data package after having generated an editable playlist. The at least one further data package may include again at least one encrypted media object and a non-editable playlist, where the non-editable playlist includes a respective reference to at least one encrypted media object in the at least one further data package. In this case, at least one referenced encrypted media object in the at least one further data package or a reference to a storage location of at least one referenced encrypted media object from the at least one further data package in the electronic device may then be added to the already generated editable playlist, instead of to a new editable playlist. In order to be able to control whether further encrypted media objects are added to a new editable playlist or to an already existing editable playlist, it may be provided that encrypted media objects in a newly received data package are added to an existing editable playlist, whenever the existing editable playlist is currently being consumed.

In one embodiment of the invention, the non-editable playlist has, for example, a Multipurpose Internet Mail Extensions compliant format.

In one embodiment of the invention, the encrypted media objects comprise, for example, OMA™ DRM protected media objects.

The encrypted media objects may be of any desired kind. They may include for example encrypted music tracks, encrypted images or video sequences. The encrypted media objects may also be of a mixed type, combining for example sound and video. The electronic device should comprise a suitable media player for the respective type of encrypted media content.

In one embodiment of the invention, the data package is a multipart Digital Rights Management Content Format package.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1 is a schematic diagram of a system according to an embodiment of the invention;

FIG. 2 is a flow chart illustrating an operation in the system of FIG. 1; and

FIG. 3 is a diagram presenting a playback format used in the operation of FIG. 2.

### DETAILED DESCRIPTION OF THE INVENTION

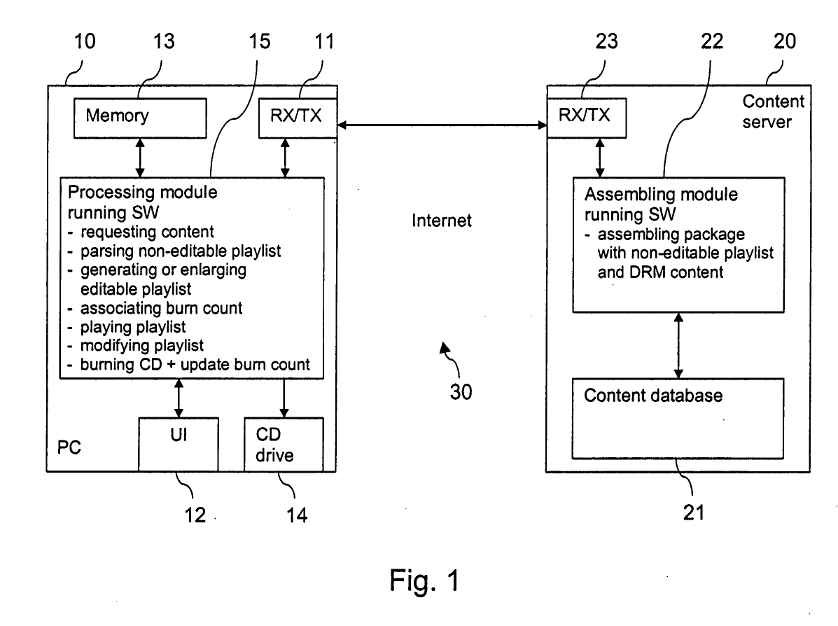

FIG. 1 is a schematic diagram of a system according to an embodiment of the invention, which enables a flexible use of DRM protected content.

The system comprises by way of example a PC 10 as an electronic device according to the invention and a content server 20 of a content provider. The PC 10 is able to access the content server 20 via the Internet 30, to which the content server 20 is connected. It is to be understood that the electronic device could also be another kind of device, for example a mobile phone, which is able to access the content server via a mobile communication network and the Internet.

The content server 20 comprises a database 21 storing a large number of DRM protected music tracks. Further, it comprises an assembling module 22, for example a data processing unit running assembling software. The assembling portion 22 is connected on the one hand to the database 12 and on the other hand to a transreceiving portion RX/TX 23, which enables a data exchange via the Internet 30.

The PC 10 comprises equally a transreceiving portion RX/TX 11, which enables a data exchange via the Internet 30. In addition, it comprises a user interface UI 12, a memory 13 and a CD drive 14. A processing module 15, for example a data processing unit running music player software, is connected to each of these components 11 to 14. The processing module 15, the user interface 12 and the memory 13 form part of a music player implemented in the PC 10. It is to be understood, however, that the same components may be used at the same time for other functions implemented in the PC 10.

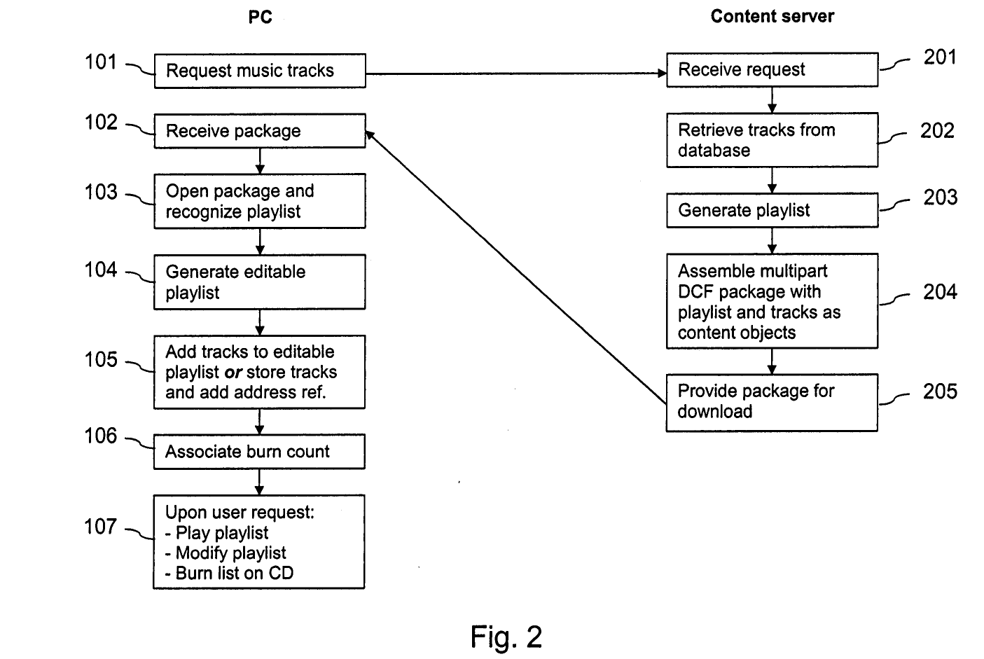

An operation in the system will now be described with reference to the flow charts of FIG. 2.

A first flow chart on the left hand side of FIG. 2 schematically illustrates an operation by the processing module 15 of the PC 10, while a second flow chart on the right hand side of FIG. 2 schematically illustrates an operation by the assembling module 22 of the content provider 20.

A user of the PC 10 may request via the user interface 12 a download of selected DRM protected music tracks from the content server 20. The processing module 15 transmits this request via the Internet 30 to the content server 20. (step 101)

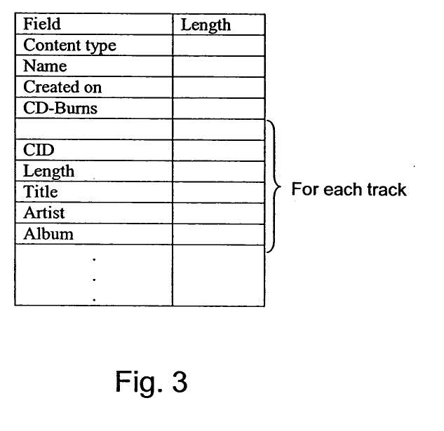

The content server 20 receives the request, which is forwarded to the assembling module 22 (step 201). The assembling module 22 retrieves thereupon the requested DRM protected music tracks from the database 21 (step 202). The assembling module 22 moreover generates a playlist based on a predefined playlist MIME format illustrated in FIG. 3 (step 203).

The playlist MIME format can be derived from an existing format, for example the m3u format, but it may have its own syntax and/or extensions. The m3u format could be modified to include the required information. The playlist MIME format is indicated by a Content-Type header information in a containing format such as the OMA™ DRM Content Format or a MIME compatible container format. The non-editable playlist format itself may have an optional field for a name of the playlist, an optional field for the creating date of the playlist and an optional field for a burn count, that is, the number of allowed CD-Burns. In addition, the playlist MIME format provides for each requested music track a field for a respective content identification (CID) in accordance with the OMA™ DRM definition, an optional field for the respective length of the music track, an optional field for the respective title of the music track, an optional field for the respective artist and an optional field for the respective album. The playlist MIME format defines on the one hand which fields are provided and on the other hand the length of the respective field.

The content type may be provided in a content type header in a DCF containing the playlist with a format similar to the following:

text/dcfplaylist

The read-only playlist itself may have a format similar to the following:

Name: MyPlaylist

Created: 2004-10-19 14:18

CD-Burns: 7

\r\n

cid:<contentid1@provider.com>

Length:180

Title: Cool song

\r\n

cid:<contentid2@provider.com>

Length:240

Title: Another Song

Artist: SomeArtist

Album: SomeAlbum

\r\n

The content type field in the DCF is used to determine the handler application, which has registered as the default handler for the content type in a device, for example a music player. The playlist format is text-based and supports arbitrary metadata headers. For example, the playlist name may be useful to differentiate between different sets of requested music tracks. The creation time of the playlist may be of interest, for example, if the right to consume the requested music tracks is only conveyed for a limited period of time. The CD-Burns field indicates by way of example that a user is allowed to copy the selected music tracks seven times to a CD. The indication “\r\n” in the above format is a carriage return-line feed (CR-LF) and represents a respective empty line, which divides the track related portions from each other and from the common portion. This makes parsing the format easier to implement.

The assembling module 22 then assembles a multipart DCF package as defined in the above-cited OMA™ DRM standard using the playlist as a first content object with the associated Content-Type header information, and the retrieved DRM protected music tracks as further content objects (step 204). The resulting package is a read-only package.

The assembled package is then provided for download (step 205). It can be put for instance into an online shopping cart.

The processing module 15 of the PC 10 then causes the actual download and receives the package via the communication network (step 102).

When receiving a multipart DCF package, the processing module 15 opens it and tries to recognize the type of the first content object from a content type field (103). It is to be understood, that the operation of processing module may be initiated either automatically or by the user of the device. The operation of processing module 15 may also be initiated afterwards, it is not necessarily initiated right after step receiving package in step 102.

If the processing module 15 recognizes that the first content object is a playlist, the processing module 15 creates a new, editable playlist (step 104).

Thereupon, the processing module 15 parses the playlist, which lists the encoded music tracks contained in the further content objects of the multipart DCF package by reference to their respective CID. The processing module 15 adds the listed music tracks to the editable playlist and stores the resulting playlist in the memory 13 (step 105). Alternatively, the processing module 15 could store the encoded music tracks listed in the non-editable playlist directly in the memory 13 and add only a reference to the respective storage address in the memory 13 to the created editable playlist. In addition to each music track, its length, its title, the artist and the album to which it belongs, as far as indicated in the non-editable playlist, may be added to the editable playlist as well. It is to be understood that the user may control the parsing process and the user may select the tracks he includes into the playlist. The editable playlist may also comprise tracks from plurality of non-editable playlists.

As the encryption of the music tracks is not tampered with when creating the new playlist, the DRM protection is not exposed.

The processing module 15 moreover associates a burn count to the editable playlist, which corresponds to the number indicated in the CD-Burns field in the non-editable playlist (step 106). The burn count can be stored for example in a secure storage section of the memory and be decremented upon each burning of the playlist onto a CD via the CD drive 14.

Now, the editable playlist can be consumed, rearranged or copied onto an audio CD in accordance with commands by a user of the PC 10 entered via the user interface 12 (step 107). For supporting such actions, additional information available in the editable playlist, like track length, title, artist and album, may be presented via the user interface 12 for a respective music track. It is to be understood, however, that such information may equally be part of the music track content itself and be retrieved from this for presentation.

Further, music tracks in other multipart DCF packages downloaded later on may be added automatically to the editable playlist, while the editable playlist is playing. The procedure is the same as described with reference to FIGS. 2 and 3, except that no new editable playlist has to be created.

As a burn count for the enlarged playlist, the lowest burn count of all included packages is used.

On the whole, it becomes apparent that an approach is presented, which is easy to implement and which enables a user to make use of a bundle of DRM protected music tracks in a flexible manner. At the same time, constraints, like the burning of a playlist to a CD, can be controlled on an application level. It is to be understood that further to music tracks, other encrypted content, like video or animation etc., could be treated in a similar manner.

While there have been shown and described and pointed out fundamental novel features of the invention as applied to a preferred embodiment thereof, it will be understood that various omissions and substitutions and changes in the form and details of the devices and methods described may be made by those skilled in the art without departing from the spirit of the invention. For example, it is expressly intended that all combinations of those elements and/or method steps, which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for supporting use of encrypted media objects, said method comprising at an electronic device:
receiving at least one data package, which at least one data package includes at least one encrypted media object and a non-editable playlist, wherein said non-editable playlist includes a respective reference to at least one encrypted media object in said at least one data package;
creating a new, editable playlist; and
adding to said editable playlist either at least one referenced encrypted media object in at least one data package or a reference to a storage location of at least one referenced encrypted media object from at least one data package in said electronic device.

2. The method according to claim 1, wherein said data package comprises an indication indicating that said at least one data package includes a non-editable playlist, which indication is recognized by said electronic device when receiving said at least one data package.

3. The method according to claim 1, wherein said non-editable playlist includes an additional attribute, which is taken into account for handling said encrypted media objects.

4. The method according to claim 3, wherein said additional attribute is a burn count indicating a number of copies which are allowed to be produced from said media objects in said at least one data package, and wherein said burn count is associated in said electronic device to said new editable playlist.

5. The method according to claim 1, further comprising:
receiving at least one further data package, which at least one further data package includes at least one encrypted media object and a non-editable playlist, wherein said non-editable playlist includes a respective reference to at least one encrypted media object in said at least one further data package; and
adding to said editable playlist either at least one referenced encrypted media object in said at least one further data package or a reference to a storage location of at least one referenced encrypted media object from said at least one further data package in said electronic device.

6. The method according to claim 1, wherein said at least one encrypted media object comprises at least one digital rights management protected media object.

7. The method according to claim 1, wherein said non-editable playlist has a Multipurpose Internet Mail Extensions compliant format.

8. The method according to claim 1, wherein said at least one data package is a multipart Digital Rights Management Content Format package.

9. An electronic device comprising a receiver and a processing module,
which processing module is adapted to receive at least one data package from said receiver, which at least one data package includes at least one encrypted media object and a non-editable playlist, wherein said non-editable playlist includes a respective reference to at least one encrypted media object in said at least one data package;
which processing module is adapted to create a new, editable playlist; and
which processing module is adapted to add to said editable playlist either at least one referenced encrypted media object in said at least one data package or a reference to a storage location of at least one referenced encrypted media object from said at least one data package in said electronic device.

10. The electronic device of claim 9, wherein said at least one media objects comprises at least one music track and wherein said electronic device comprises at least a music player.

11. A data communication system comprising an electronic device, which electronic device includes a processing module,
which processing module is adapted to receive at least one data package, which at least one data package includes at least one encrypted media object and a non-editable playlist, wherein said non-editable playlist includes a respective reference to at least one encrypted media object in said at least one data package;
which processing module is adapted to create a new, editable playlist; and
which processing module is adapted to add to said editable playlist either at least one referenced encrypted media object in said at least one data package or a reference to a storage location of at least one referenced encrypted media object from said at least one data package in said electronic device.

12. A software program product in which a software code for supporting a use of encrypted media objects is stored, said software code realizing the following steps when running in an electronic device:
receiving at least one data package, which at least one data package includes at least one encrypted media object and a non-editable playlist, wherein said non-editable playlist includes a respective reference to at least one encrypted media object in said at least one data package;
creating a new, editable playlist; and
adding to said editable playlist one of the following: at least one referenced encrypted media object in said at least one data package and a reference to a storage location of at least one referenced encrypted media object from said at least one data package in said electronic device.

13. A method for supporting a use of encrypted media objects at an electronic device, said method comprising at a content server providing a data package including at least one encrypted media object to an electronic device:
generating a non-editable playlist, wherein said non-editable playlist includes a respective reference to at least one encrypted media object which is to be included in said data package;
assembling said non-editable playlist and at least one encrypted media object in said data package; and
providing said data package for transmission to said electronic device.

14. A content server comprising a transmitter for providing encrypted media objects to electronic devices, said content server further comprising an assembling module,
which assembling module is adapted to generate a non-editable playlist, wherein said non-editable playlist includes a respective reference to at least one encrypted media object which is to be provided by said content server to an electronic device;
which assembling module is adapted to assemble said non-editable playlist and said at least one encrypted media object in a data package; and
which assembling module is adapted to provide said data package for transmission to an electronic device from said transmitter.

15. A data communication system comprising a content server having a transmitter for providing encrypted media objects to electronic devices, said content server further comprising an assembling module,
which assembling module is adapted to generate a non-editable playlist, wherein said non-editable playlist includes a respective reference to at least one encrypted media object which is to be provided by said content server to an electronic device;
which assembling module is adapted to assemble said non-editable playlist and said at least one encrypted media object in a data package; and
which assembling module is adapted to provide said data package for transmission to an electronic device from said transmitter.

16. A software program product in which a software code for supporting a use of encrypted media objects at an electronic device is stored, said software code realizing the following steps when running in a content server which is to provide a data package including at least one encrypted media object to said electronic device:
generating a non-editable playlist, wherein said non-editable playlist includes a respective reference to at least one encrypted media object which is to be included in said data package;
assembling said non-editable playlist and at least one encrypted media object in said data package; and
providing said data package for transmission to said electronic device.

17. A playlist format for a non-editable playlist which is to be assembled together with at least one encrypted media object in a data package for storage on a computer readable medium, said playlist format defining:
a respective field for a reference to at least one media object which is to be included in said data package.

18. The playlist format according to claim 17 further comprising at least one of:
a field for indicating a maximum number of allowed CD burns;
a field for indicating a creation date;
a field for indicating a title of said playlist;
for at least one media object a field for a content identification as said reference;
for at least one media object a field for indicating a length of said media object; and
for at least one media object a field for indicating a title of said media object.
